(19) United States
(12) Patent Application Publication
(10) Pub. No.: US 2001/0044895 A1
(43) Pub. Date: Nov. 22, 2001

(54) User authentication method, and storage medium, apparatus and system therefor

(75) Inventor: Satoshi Hada, Tokyo-to (JP)

Correspondence Address: IBM CORPORATION, INTELLECTUAL PROPERTY LAW DEPT., P.O. BOX 218, YORKTOWN HEIGHTS, NY, 10598, US

(73) Assignee: International Business Machines Corporation, Armonk, NY (US)

(21) Appl. No.: 09/819,359

(22) Filed: Mar. 28, 2001

(30) Foreign Application Priority Data
Mar. 31, 2000 (JP) 2000-099867

(51) Int. Cl. H04L 9/00

(52) U.S. Cl. 713/168

(57) ABSTRACT

The invention provides a user authentication method and apparatus whereby, even when multiple verifiers correspond with a prover, safe user authentication is ensured while zero knowledge property is acquired. In an example embodiment, at step 1, a prover calculates A=F(g, a) using a random number a, and transmits A to a verifier (process Ps1, communication T1). At step 2, the verifier uses a random number b to calculate cryptograms B=F(g, b) and X=F(A, b), and transmits B and X to the prover (process Qs1, communication T2). At step 3, the prover determines whether X=F(B, a) has been established. If X=F(B, a) has not been established, the prover halts performance of the protocol procedures. If X=F(B, a) has been established, the prover 10 uses a random number c to calculate C=F(g, c) and Y=F(B, c) and thereafter calculates Z=H(a, Y, s), and then transmits C, Y and Z to the verifier 40 (process Ps2, communication T3). At step 4, the verifier determines whether Y=F(C, b) and A=J(v, Y, g, Z) have been established. If Y=F(C, b) and A=J(v, Y, g, Z) have been established, the verifier 40 accepts the identity of the prover 10. If Y=F(C, b) and A=J(v, Y, g, Z) have not been established, the verifier rejects the identity of the prover (process Qs2).

### FIELD OF THE INVENTION

The present invention relates to a user authentication method used, for example, for a computer system connected to a network; a storage medium on which a user authentication program is stored; a user authentication apparatus; and a user authentication system. In particular, the present invention pertains to a user authentication method, for authenticating relations existing between a prover computer, equipped with a public key, and a plurality of verifier computers; a storage medium on which such a user authentication program is stored; and a user authentication apparatus and an authentication system therefor.

### BACKGROUND ART

On a network, users are often required to participate in some sort of authentication process to identify themselves. An authentication process in this case refers to a process whereby a prover, by following the rules of a specific protocol, proves his or her identity to a verifier, a requisite electronic commerce technique. When, for example, a user desires to prove his or her identity to a server, the user functions as a prover and the server functions as a verifier. Whereas when a server desires to prove its identity to a user, the server functions as a prover and the user functions as a verifier. Such authentication techniques are not limited in their application to intercourse between users and servers, but are widely employed as mutual identification methods by arbitrarily paired computers. Recently, the user authentication processes that are employed are based on public key encryption: a prover has both a public key and a secret key, and when the prover desires to prove his or her identity, he or she employs a specific protocol to notify a verifier that he or she has a secret key that corresponds to the public key.

The Schnorr method is a well known, representative user authentication technique (“Efficient Signature Generation by Smart Cards”, C. P. Schnorr, Journal of Cryptology, Vol. 4, No. 3, pp.161-174, 1991). According to this technique, a prover proves to a verifier that he or she holds a secret key corresponding to a public key.

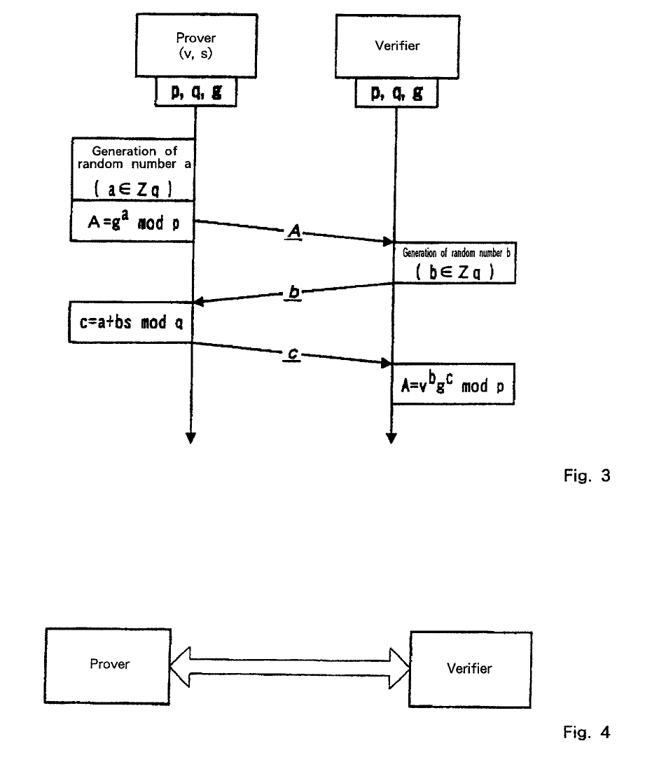

As one conventional example, a summary of Schnorr's user authentication method will now be given while referring to FIG. 3. System parameters used by this method are prime numbers p and q (q|p-1) and the element g ε Zp of the order q. The public key of the prover is v (v=g^{-s} mod p), and the secret key of the prover is s ε Zq. In the following explanation, assume that the prover and the verifier obtain in advance the prime numbers p and q and the element g, which are system parameters, and that the verifier obtains in advance the public key v of the prover.

According to this method, the verifier and the prover exchange data in the following manner.

Step 1: The prover generates a random number a ε Zq, calculates A=g^{a} mod p, and transmits it to the verifier.

Step 2: The verifier generates a random number b (b ε Zq), and transmits it to the prover.

Step 3: The prover calculates c=a+bs mod q, and transmits it to the verifier.

Step 4: The verifier determines whether A=V^{b}g^{c} mod p is established. If this equation is established, the verifier ascertains that the identity of the prover is correct. If this equation is not established, the verifier ascertains that the identity of the prover is incorrect, and rejects the communication.

The Schnorr method is the most efficient of all the methods based on the discrete logarithm program, and only three communications are required. However, the safety of the communications is not guaranteed. That is, in the process of following the procedures defined in the protocol and communicating across the network, the secret key s of the prover may be revealed.

Therefore, the safety of such a data exchange between prover and verifier should be evaluated, i.e., the user authentication process (the exchange of messages, etc.). For this evaluation, i.e., of the safety of the user authentication process, a zero-knowledge technique is well known (“The Knowledge Complexity of Interactive Proofs”, S. Goldwasser, S. Micali, and C. Rackoff, Proceedings of 17th Symposium on Theory of Computing, pp. 291-304, 1985). In this instance, the zero knowledge property represents that no information concerning the secret key of the prover is revealed, and thus, when the zero knowledge property is achieved, the safety of the user authentication method is guaranteed.

The zero knowledge property can be achieved by a partial correction to the Schnorr authentication method (“How to prove yourself: practical solution to identification and signature problems”, A. Fiat and A. Shamir, Proceedings of Crypto′ 86, 1980). Specifically, when the Schnorr authentication method is corrected so that the verifier generates a random number b ε {0, 1} and so that the procedures in the protocol are sequentially performed O (log q) times, the zero knowledge property is achieved. That is, when the subsequent protocol procedures are performed O (log q) times, and if the verifier accepts the identity of the prover in all the performances of the protocol procedures, the identity of the prover is verified.

Protocol]

Step 1: The prover generates a random number a ε Zq, calculates A=g^{a} mod p and transmits the random number A to the verifier.

Step 2: The verifier generates a random number b ε {0, 1}, and transmits the random number b to the prover.

Step 3: The prover calculates c=a+b s mod q, and transmits the result c to the verifier.

Step 4: The verifier determines whether A=v^{b}g^{c} mod p has been established. When the equation has been established, the verifier concludes that the identity of the prover is correct. If the equation is not established, the verifier concludes that the identity of the prover is incorrect, and rejects the communication.

As described above, although the number of communications is increased to O(log q), the zero knowledge property is achieved. Besides the Schnorr method, many other user authentication methods have been proposed that achieve the zero knowledge property.

Problems to be Solved by the Invention]

However, to achieve the zero knowledge property for the conventional user authentication, it is proposed that one prover correspond to one verifier, and that the zero knowledge property will be achieved only when the prover and the verifier complete the performance of the protocol procedures using one-to-one correspondence (see FIG. 4). That is, when the prover must perform the protocol with multiple verifiers, there is no guarantee that the zero knowledge property will be achieved (“Concurrent Zero-Knowledge”, C. Dwork, M. Naor and A. Sahai, Proc. Of 30th STOC, 1998).

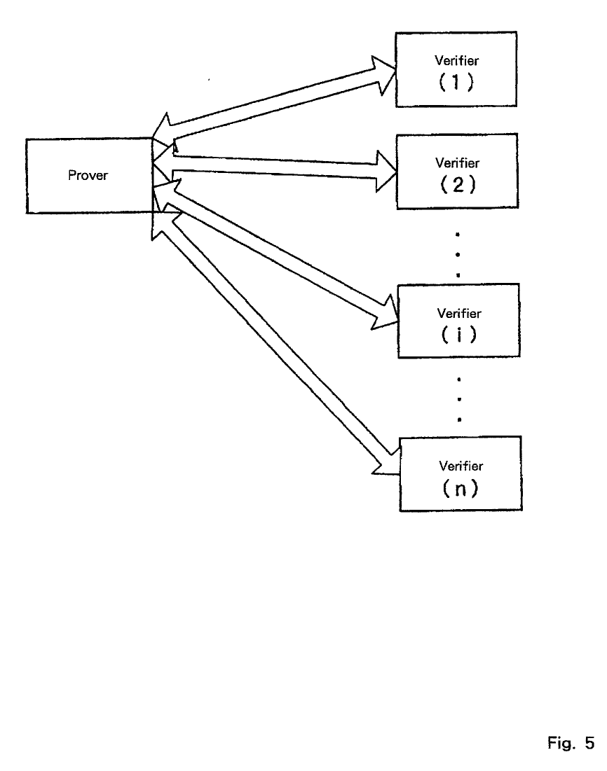

For example, on an asynchronous network, such as the Internet, multiple computers simultaneously communicate with each other, and a prover may also be required to simultaneously perform the protocol procedures with multiple verifiers. On the WWW (the World Wide Web), an HTTP (Hyper Text Transfer Protocol: the protocol used by WWW servers and WWW browsers or Web browsers to exchange such data as files) server is requested to verify its identity through simultaneous communication exchanges with multiple connected clients (see FIG. 5)

### SUMMARY OF THE INVENTION

To resolve the above shortcoming, it is one object of the present invention to provide a user authentication method whereby, even when multiple verifiers are in simultaneous communication with a prover, a user can be safely authenticated while at the same time the zero knowledge property is achieved, as well as a storage medium on which such a user authentication program is stored, and a user authentication apparatus and a user authentication system therefor.

To achieve the above object, according to one aspect of the present invention, a user authentication method, whereby a one-way function F, which should satisfy v=F(g, −s), is determined by employing an integer g that is defined in advance for a relation between a public key v and a secret key s of a prover computer, and whereby a relation is verified between the prover computer and each of multiple verifier computers, comprises the steps of: the prover computer generating a random number a, obtaining a cryptogram A=the function F(g, a), and transmitting the cryptogram A to the verifier computers; the verifier computers generating a random number b, obtaining a cryptogram B=the function F(g, b) and a cryptogram X=the function F(A, b), and transmitting the cryptograms B and X to the prover computer; the prover computer determining whether a relation of the cryptogram X=the function F(B, a) has been established and generating a random number c when the relation has been established, obtaining a cryptogram C=the function F(g, c) and a cryptogram Y=the function F(B, c), or a cryptogram C=the function F(A, c), a cryptogram Y=the function F(X, c) and a cryptogram Z=a function H(a, Y, s), and transmitting the cryptograms C and Y or the cryptograms C, Y and Z to the verifier computers; and the verifier computers, when the cryptogram Y=the function F(C, b) and the cryptogram A=a function J(v, Y, g, Z) are established, determining that the relation between the prover computer and the verifier computer is correct.

The public key v is obtained by employing prime numbers p and q that satisfy (q|p - 1), and by defining an element of the order q as the integer g.

By using the public key v and the secret key s, the function F acquires a relation v=F(g, −s)=g^{-s} mod p.

When a relation X=B^{a} mod p is established, the prover computer generates the random number c. The function H has a relation H(a, Y, s)=a+Ys mod q. The function J has a relation J(v, Y, g, Z)=v^{Y}g^{z} mod p.

According to another aspect of the invention, a storage medium is provided on which a user authentication program, which is to be read by a prover computer, is stored whereby a one-way function F, which should satisfy v=F(g, −s), is determined by employing an integer g, which is defined in advance for the relation between a public key v and a secret key s of the prover computer, and whereby a relation is verified between the prover computer and each of multiple verifier computers, the user authentication program permitting the prover computer to perform: a process for generating a random number a and for obtaining a cryptogram A=the function F(g, a), and for transmitting the cryptogram A to the verifier computers; a process for receiving cryptograms B and X from the verifier computer, and for employing the cryptograms to determine whether a relation a cryptogram X=the function F (B, a) has been established; a process for generating a random number c when the relation has been established; and a process for obtaining a cryptogram C=the function F(g, c) and a cryptogram Y=the function F(B, c), or a cryptogram C=the function F(A, c), a cryptogram Y=the function F(X, c) and a cryptogram Z=the function H(a, Y, s); and a process for transmitting the cryptograms C and Y, or C, Y and Z, to the verifier computers.

According to an additional aspect of the present invention, a storage medium is provided on which is stored a user authentication program, which is to be read by a prover computer, whereby a one-way function F, which should satisfy v=F(g, −s), is determined by employing an integer g, which is defined in advance for the relation between a public key v and a secret key s of the prover computer, and whereby a relation is verified between the prover computer and each of multiple verifier computers, the user authentication program permitting the verifier computers to perform: a process for receiving a cryptogram A from the prover computer and for generating a random number b; a process for obtaining a cryptogram B=the function F(g, b) and a cryptogram X=the function F(A, b), using the random number b and the cryptogram that is received, and for transmitting the cryptograms B and X to the prover computer; a process for receiving, from the prover computer, a cryptogram C=the function F(g, c) and a cryptogram Y=the function F(B, c), or a cryptogram C=the function F(A, c), a cryptogram Y=the function F(X, c) and a cryptogram Z=the function H(a, Y, s); and a process, based on the cryptograms C and Y or C, Y and Z that are received, for verifying a relation between the verifier computer and the prover computer when two relations of the cryptogram Y=the function F(C, b) and the cryptogram A=the function J(v, Y, g, Z) are established at the same time.

According to a further aspect of the present invention, a user authentication apparatus is provided for a prover computer, wherein a one-way function F, which should satisfy v=F(g, −s), is determined by employing an integer g, which is defined in advance, for a relation between a public key v and a secret key s of the prover computer, and wherein a relation is verified between the prover computer and each of multiple verifier computers, the user authentication apparatus comprising: transmission means, for generating a random number a and obtaining a cryptogram A=the function F(g, a), and for transmitting the obtained cryptogram A to the verifier computers; reception means, for receiving cryptograms B and X from the verifier computers; verification means, for employing the cryptograms B and X to determine whether a relation of the cryptogram X=the function F(B, a) has been established; cryptogram computation means, for generating a random number c when it has been ascertained that the relation has been established, and for obtaining a cryptogram C=the function F(g, c) and a cryptogram Y=the function F(B, c), or a cryptogram C=the function F(A, c), a cryptogram Y=the function F(X, c) and a cryptogram Z=the function H(a, Y, s); and cryptogram transmission means, for transmitting the cryptograms C and Y or C, Y and Z to the verifier computers.

According to a still further aspect of the prevent invention, a user authentication apparatus is provided for a prover computer wherein a one-way function F, which should satisfy v=F(g, −s), is determined by employing an integer g, which is defined in advance, for the relation between a public key v and a secret key s of a prover computer, and wherein a relation is verified between the prover computer and each of multiple verifier computers, the user authentication apparatus comprising: reception means, for receiving a cryptogram A from the prover computer; transmission means, for generating a random number b, and for employing the random number b and the cryptogram A that is received to obtain a cryptogram B=the function F(g, b) and a cryptogram X=the function F(A, b), and for transmitting the cryptograms B and X to the prover computer; cryptogram reception means, for receiving from the prover computer a cryptogram C=the function F(g, c) and a cryptogram Y=the function F(B, c) or a cryptogram C=the function F(A, c), a cryptogram Y=the function F(X, c), and a cryptogram Z=the function H(a, Y, s); and verification means, for performing a procedure, based on the cryptograms C, Y and Z that are received, for verifying a relation between the verifier computers and the prover computer when two relations of the cryptogram Y=the function F(C, b) and the cryptogram A=the function J(v, Y, g, Z) are established at the same time.

According to yet one more aspect of the present invention, a user authentication system comprises: the above described user authentication apparatus for the prover computer; and a plurality of the above described user authentication apparatuses for the verifier computers.

According to yet another aspect of the present invention, a user authentication system, wherein a one-way function F, which should satisfy v=F(g, −s), is determined by employing an integer g, which is defined in advance, for the relation between a public key v and a secret key s of a prover computer, and wherein a relation is verified between the prover computer and each of multiple verifier computers, comprises: transmission means, for the prover computer, for generating a random number a and obtaining a cryptogram A=the function F(g, a), and for transmitting the obtained cryptogram A to the verifier computers; reception means for the verifier computers, for receiving the cryptogram A from the prover computer; transmission means for the verifier computers, for generating a random number b with which the cryptogram A is employed to obtain a cryptogram B=the function F(g, b) and a cryptogram X=the function F(A, b), and for transmitting the cryptograms B and X to the prover computer; reception means for the prover computer, for receiving the cryptograms B and X from the verifier computers; verification means for the prover computer, for employing the cryptograms B and X to determine whether a relation of the cryptogram X=the function F(B, a) has been established; cryptogram computation means for the prover computer, for generating a random number c when it is ascertained that the relation has been established, and for obtaining the cryptogram C=the function F(g, c) and the cryptogram Y=the function F(B, c), or the cryptogram C=the function F(A, c) and the cryptogram Y=the function F(X, c), and a cryptogram Z=the function H(a, Y, s); and cryptogram transmission means for the prover computer, for transmitting the cryptograms C, Y and Z to the verifier computers; cryptogram reception means, for the verifier computers, for receiving the cryptograms C, Y and Z from the prover computer; and verification means for the verifier computers, for employing the cryptograms C, Y and Z that are received to verify a relation between the verifier computers and the prover computer when two relations of the cryptogram Y=the function F(C, b) and the cryptogram A=the function J(v, Y, g, Z) are established at the same time.

### PREFERRED EMBODIMENT

The preferred embodiment of the present invention will now be described while referring to the accompanying drawings. In this embodiment, the invention is applied for a case wherein a public key v and a secret key s are used for user authentication on a network.

The present invention relates to user authentication for an asynchronous network, such as the Internet. In the asynchronous network, multiple verifiers may request a prover to execute a protocol for user authentication. That is, in this embodiment, there are multiple verifiers for one prover.

In this embodiment, the following one-way function F is employed as an encryption function. Assume that the one-way function F is a two-input and one-output function, and that two calculations, addition (+) and multiplication (*) are defined by the range and a second variable range of a function. Further, the function F satisfies the following two properties. That is, for arbitrary an a and b, the following relations must be established:

(1) F(g, a+b)=F(g, a)*F(g, b)

(2) if A=F(g, a), F(g, a*b)=F(A, b).

Another encryption function H, which is a three-input and one-output function, is represented as follows.

H(a, Y, s)=a+Y*s

wherein the addition and multiplication are the ones defined in the second variable range of the function F. Furthermore, an additional encryption function J, which is a four-input and one-output function, is represented as follows using the function F.

J(v, Y, g, Z)=F(v, Y)*F(g, Z).

The one-way function based on the discrete logarithm can be a specific example for the function F. As a typical example, when a relation q|p-1 is established for prime numbers p and q and when g ε Zp is the element of the order q, F(g, a)=g^{a} mod p.

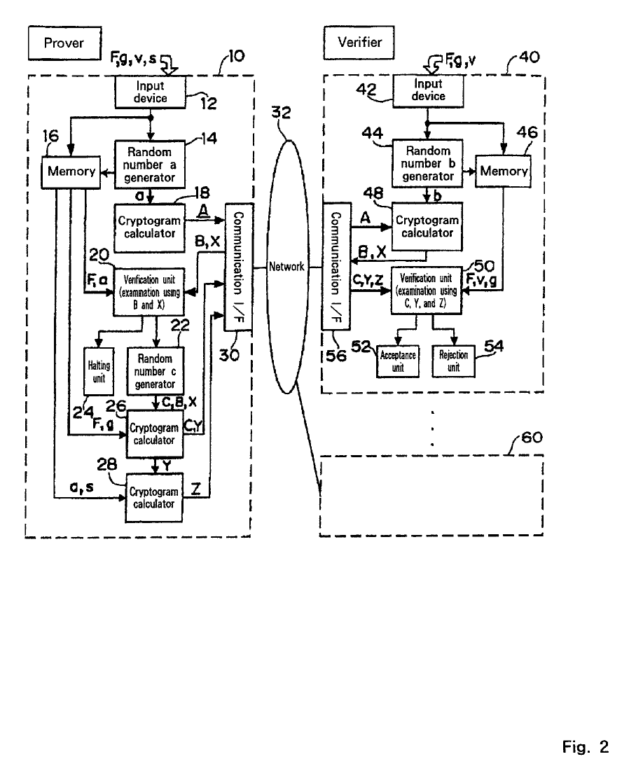

A system for which the present invention can be applied is shown in FIG. 2. A prover computer 10 and a verifier computer 40, which include at the least a CPU, and additional verifier computers 60 having the same configuration as the verifier computer 40 are connected to a network 32. As is shown in FIG. 2, in this embodiment, a one-to-multiple connection is established between the prover computer and the verifier computers.

The prover computer 10 includes an input device 12, for entering system parameters, is connected to a random number generator 14, for generating a random number a in accordance with the input, and a memory 16. The random number generator 14 is connected to the memory 16 and a cryptogram calculator 18, for obtaining a cryptogram A based on the random number a. The cryptogram calculator 18 is connected to a communication interface (hereinafter referred to as a communication I/F) 30, which in turn is connected to the network 32, to facilitate communications with other apparatuses via the network 32. A verification unit 20 is connected both to the communication I/F 30 and to the memory 16. A random number generator 22, for generating a random number c in accordance with the input, and a halting unit 24, for employing an input signal to halt a protocol that will be described later, are connected to the verification unit 20. The random number generator 22 is connected to a cryptogram calculator 26, for obtaining cryptograms C and Y, based on the random number c. The cryptogram calculator 26 is connected to a cryptogram calculator 28, for obtaining a cryptogram Z, based on the cryptograms C and Y. And the cryptogram calculators 26 and 28 are connected both to the communication I/F 30 and to the memory 16.

The verifier computer 40 includes an input device 42, for entering system parameters, that is connected to a random number generator 44, for generating a random number b in accordance with the input, and a memory 46. The random number generator 44 is connected to the memory 46 and a cryptogram calculator 48, for obtaining cryptograms B and X based on the random number b. The cryptogram calculator 48 is connected to a communication I/F 56, which is connected to the network 32 to facilitate communications with other apparatuses via the network 32. A verification unit 50 is connected both to the communication I/F 56 and to the memory 46. And an acceptance unit 52 and a rejection unit 54 are connected to the output side of the verification unit 50.

Since the verifier computer 60 has the same configuration as the verifier computer 40, no detailed explanation for it will be given. In the following description, wherein the verifier computer 40 is used as a typical configuration, the names of its individual sections are employed.

The protocol for this embodiment will now be described. It should be noted that the system parameter is a function F_{g}, the public key of a prover is v=F(g, −s), and the secret key of the prover is s.

Protocol

Step 1:

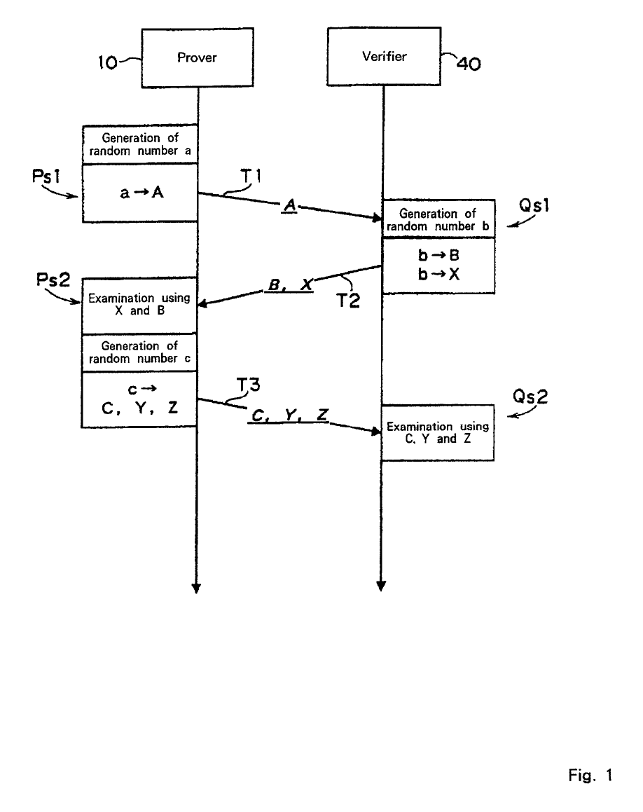

A prover generates the random number a using the random number generator 14, obtains a cryptogram A=F(g, a) using the cryptogram calculator 18, and transmits the cryptogram A to verifiers via the communication I/F 30. Step 1 corresponds to a process Ps1, which is performed by the prover computer 10 in FIG. 1, and communication T1, which is transmitted as a result of the process Ps1.

Step 2:

The verifier generates the random number b using the random number generator 44, and employs the received cryptogram A to obtain a cryptogram B=F(g, b) and a cryptogram X=F(A, b). The verifier then transmits the obtained cryptograms B and X to the prover via the communication I/F 30. Step 2 corresponds to a process Qs1, which is performed after the verifier computer 40 in FIG. 1 has received the data accompanying the communication T1, and to communication T2, which is transmitted as a result of the process Qs1.

Step 3:

Based on the received cryptograms B and X, the prover employs the verification unit 20 to determine whether X=F(B, a) has been established for the verifier. If X=F(B, a) has not been established for the verifier, the prover ascertains that the verifier performed an illegal activity, and halts the performance of the protocol procedures using the halting unit 24. If, however, X=F(B, a) has been established for the verifier, the prover generates the random number c and obtains C=F(g, c) and Y=F(B, c), or alternately, obtains C=F(A, c) and Y=F(X, c). Afterwards, Z=H(a, Y, s), i.e., Z=a+Y*s is calculated, and then the obtained cryptograms C, Y and Z are transmitted to the verifier. Step 3 corresponds to a process Ps2, which is performed after the prover computer 10 in FIG. 1 has received the data accompanying the communication T2, and to communication T3, which is transmitted because the relation X=F(B, a) was verified by the verification unit 20 during the process Ps2.

Step 4:

Based on the received cryptograms C, Y and Z, the verifiers uses the verification unit 50 to determine whether Y=F(c, b) and A=J(v, Y, g, Z), i.e., A=F(v, Y)*F(g, Z), have been established. If the two relations have been established, the verifier accepts the identity of the prover (the acceptance unit 52 is activated). If, however, the two relations have not been established, the verifier rejects the identity of the prover (the rejection unit 54 is activated). Step 4 corresponds to a process Qs2 performed after the verifier computer 40 in FIG. 1 has received the data accompanying the communication T3.

The above protocol can be stored as a program, for use by the prover and the verifiers, on a storage medium, such as a floppy disk. In this case, only a detachable floppy disk unit (FDU) need be connected to the individual computers to enable the program to be read from the floppy disk and executed. A processing program may be stored (installed) in a RAM, or at another storage area (e.g., on a hard disk) in the computer, and executed, or it may be stored in a ROM in advance. A storage medium, a disk such as a CD-ROM, an MD, an MO or a DVD, or a magnetic tape such as a DAT, may also be used, but when one of these media is employed, a corresponding device, such as a CD-ROM drive, an MD drive, an MO drive, a DVD drive or a DAT drive must be provided.

### Specific Example

A specific example of user authentication for which the above described protocol is employed will now be described. In the following example, when prime numbers p and q (q|p - 1) and the element g of the order q are employed as system parameters, v=F(g, −s)=g^{-s} mod p is employed as the function F. That is, the same key configuration as that provided by the Schnorr method can be employed. Further, the function H is defined as H(a, Y, s)=a+Y s mod q, and the function J is defined as J(v, Y, g, Z)=v^{Y}g^{z} mod p.

Key Configuration]

System parameters: prime numbers p and q (q|p - 1) and the element g of the order q Public key of a prover: v=g^{-s} mod p Secret key of a prover: s ε Zq

Protocol]

Step 1: The prover generates the random number a, acquires a cryptogram A and transmits the cryptogram A to the verifier.

a ε Zq (1)

A=g^{a} mod p (2)

That is, at the prover computer 10, the random number generator 14 employs the system parameter q to generate the random number a, in accordance with expression (1), and the cryptogram calculator 18 employs the random number a and the system parameters p and q to obtain the cryptogram A, in accordance with expression (2). The obtained cryptogram A is then output through the communication I/F 30, and is transmitted, via the network 32, to the verifier computer 40. Step 2: The verifier generates the random number b, obtains cryptograms B and X, and transmits the cryptograms B and X to the prover.

b ε Zq (3)

B=g^{b} mod p (4)

X=A^{b} mod p (5)

That is, at the verifier computer 40, the cryptogram calculator 48 receives the cryptogram A, generated by the prover computer 10, via the communication I/F 56. At this time, the random number generator 44 of the verifier computer 40 employs the system parameter q to generate the random number b, in accordance with expression (3). The cryptogram calculator 48 then employs the random number b and the received cryptogram A to obtain the cryptograms B and X, in accordance with expressions (4) and (5), and the obtained cryptograms B and X are output through the communication I/F 56 and are transmitted, via the network 32, to the prover computer 10.

Step 3: The prover employs the cryptograms B and X to determine whether the following expression (6) has been established. If expression (6) has not been established, the prover assumes that the verifier performed an illegal activity and halts the protocol. If, however, expression (6) has been established, the prover generates the random number c and obtains cryptograms C and Y. Thereafter, a cryptogram Z is acquired, and the cryptograms C, Y and Z are transmitted to the verifier.

X=B^{a} mod p (6)

c ε Zq (7)

C=g^{c} mod p (8)

Y=B^{c} mod p (9)

or C=A^{c} mod p (10)

Y=X^{c} mod p (11)

Z=a+Y s mod q (12)

Specifically, at the prover computer 10 the verification unit 20 receives the cryptograms B and X from the verifier computer 40 via the communication I/F 30, and employs the cryptograms B and X that are received and the system parameters stored in the memory 16 to examine the cryptograms B and X, in accordance with expression (6). If expression (6) has not been established, the verification unit 20 transmits a signal to the halting unit 24 to halt the performance of the protocol procedures. When expression (6) has been established, however, the verification unit 20 outputs a signal to the random number generator 22 to generate the random number c at the random number generator 44 based on the system parameter q, following which the random number c is transmitted to the cryptogram calculator 26, which employs the random number c, the received cryptogram B and the system parameters p and g to obtain cryptograms C and Y, in accordance with expressions (8) and (9), or (10) and (11). Then, in accordance with expression (12), the cryptogram calculator 26 obtains a cryptogram Z using the obtained cryptogram Y, the random number a, the secret key s and the system parameter q, and thereafter, the cryptograms C, Y and Z are output through the communication I/F 30, and are transmitted, via the network 32, to the verifier computer 40.

Step 4: The verifier determines whether the following expressions (13) and (14) have been established. If the two expressions have been established, the verifier accepts the identity of the prover. Otherwise, the verifier rejects the identity of the prover.

Y=C^{b} mod p (13)

A=v^{Y}g^{Z} mod p (14)

Specifically, in the verifier computer 40, the verification unit 50 receives the cryptograms C, Y and Z from the prover computer 10 via the communication I/F 56. Then, in accordance with expressions (13) and (14), the verification unit 50 examines the cryptograms C, Y and Z using the system parameters stored in the memory 46. When expressions (13) and (14) have not been established, the verification unit 50 activates the rejection unit 54 to reject the identity of the prover. When, however, the expressions (13) and (14) have been established, the verification unit 50 activates the acceptance unit 52 to accept the identity of the prover.

In this embodiment, user authentication can be completed through the exchange of only three communications by the prover and the verifier, and the quantity of the communications contributes to the prime numbers p and q. According to this embodiment, the number of communications is |p|, using the cryptogram A accompanying communication T1, 2|p|, using the cryptograms B and X accompanying communication T2, and 2|p| and |q|, using the cryptograms C, Y and Z accompanying communication T3 (see FIG. 1). Therefore, a total of only 5|p|+|q| communications is required. Further, as is apparent from the above expressions, this contributes greatly to the reduction of the load imposed by the calculation of powers. Since only six such calculations are required, an efficient protocol is provided. In this example, communication between one prover and a single verifier (one verifier) has been employed. However, on an asynchronous network, such as the Internet, the authentication of the identity of a prover must be accomplished by multiple verifiers. In this embodiment, when individual verifiers are in any of the communication states corresponding to communication T1 to communication T3 (see FIG. 1), secrecy can be maintained; a secret key will not be compromised even when the cryptograms A, B, C, X, Y and Z that are transmitted are trapped en route and analyzed. This will be explained later in detail. Therefore, even when multiple verifiers must simultaneously or sequentially be permitted to examine the identity of a prover, the user authentication process can be precisely performed for each of the multiple verifiers. Thus, when multiple verifiers are permitted to examine the identity of a prover via an asynchronous network, such as the Internet, the user authentication process can be performed safely.

In the above example, the power calculation for Zp is employed as a specific one-way function F, and is a so-called one-way function based on a discrete logarithm. However, the present invention is not limited to this problem; while N is a composite number, the discrete logarithm for ZN may be employed, or the discrete logarithm for an elliptic curve may be employed.

Validity of protocol]

The validity of the protocol for this embodiment will now be described. Specifically, an explanation will be given based on the above Specific example wherein it is shown that the zero knowledge property is achieved, even when the protocol for this embodiment is applied for an asynchronous network. Whereas it is well known that the zero knowledge property is not achieved when the protocol mentioned in the description of the background art (“Concurrent Zero-Knowledge”, C. Dwork, M. Naor and A. Shai, Proc. Of 30th STOC, 1998) is applied for an asynchronous network.

On an asynchronous network, a plurality of illegal verifiers (V1, V2, . . . and Vn) may enter into a conspiracy with each other to communicate with a prover P. Therefore, it is not sufficient to consider the achievement of the zero knowledge property for communications between a prover P and a single verifier V. In other words, the zero knowledge property for communications between a prover P and multiple verifiers V1 to Vn must be taken into account.

In the authentication process in this embodiment, it is proved that the information that can be obtained through communication, in accordance with the proposed protocol, with the prover P by multiple illegal verifiers V1 to Vn, who have entered into a conspiracy with each other, can be obtained without the communication with the prover P. Specifically, it is proved for arbitrary illegal verifiers V1 to Vn, there is an algorithm S (simulator) such that the probability distribution of the output of S matches the one of the contents of the actual communications exchanged by the prover P and each verifier V1 to Vn. In this embodiment, this proof is represented as “the algorithm S simulates the contents of the actual communication between the prover P and each verifier V1 to Vn”.

Conspiracy of verifiers]

It may be assumed that, without losing generality, the illegal verifiers V1 to Vn in a conspiracy communicate with the prover P in the following manner. The verifiers V1 to Vn are sorted into groups G1, G2, . . . and Gm (m≦n). Intuitively, it is assumed that a verifier who belongs to the group G₁ communicates with the prover P based on information obtained by a verifier who belongs to the group Gᵢ₋₁.

Generalized conspiracy protocol]

The input data are employed as the public key for the prover P and as the system parameters (p, q, g, v).

Step 1: The prover P calculates cryptograms A1=g^{al}, A2=g^{a2}, . . . and An=g^{an} mod p, and transmits the obtained cryptograms A1, A2, . . . and An to the respective verifiers V1, V2, . . . and Vn. The information obtained by the verifiers V1 to Vn is VIEWₒ={(p, g, g, v) , (A1, A2, . . . , An)}.

Step 2-1-P: All the verifiers Vi who belong to the group G1 employ the received cryptograms A1 to An to generate a random number bi ε Zq, and obtain cryptograms Bi (=g^{bi} mod p) and Xi (=Ai^{b1} mod p). The verifiers Vi then transmit the obtained cryptograms Bi and Xi to the prover P.

Step 2-1-V: The prover P examines each i that satisfies Vi ε Gi to determine whether the authentication expression (Xi=B^{a1} mod p) has been established. If the authentication expression has been established, the prover P transmits the cryptograms Ci, Yi and Zi to the verifiers Vi. At this time, the information obtained by the verifiers is VIEW₁=VIEWₒ∪{(Bi, Xi, Ci, Yi, Zi)|Vi εG1}.

Then, steps 2-k-P and 2-k-V are repeated for 2≦k≦n.

Step 2-k-P: All the verifiers Vi who belong to the group Gk employ the obtained information VIEWₖ₋₁ to generate a random number bi ε Zq, and obtain cryptograms Bi (=g^{bi} mod p) and Xi (=Ai^{bi} mod p). The verifiers Vi then transmit the obtained cryptograms Bi and Xi to the prover P.

Step 2-k-V: The prover P examines each i that satisfies Vi ε Gk to determine whether the authentication expression (Xi=B^{a1} mod p) has been established. If the authentication expression has been established, the prover P transmits the cryptograms Ci, Yi and Zi to the verifiers Vi. At this time, the information obtained by the verifiers is VIEWₖ=VIEWₖ₋₁∪{(Bi, Xi, Ci, Yi, Zi)|Vi ε Gk}.

As a result, the information finally obtained by the verifiers who are members of the conspiracy is

$${VIEW}_{n} = \{ ( p , q , g , v ) , ( A 1 , A 2 , … , An ) , ( B 1 , B 2 , … , Bn ) , ( X 1 , X2 , … , Xn ) , ( C 1 , C2 , … , Cn ) , ( Y 1 , Y 2 , … , Yn ) , ( Z 1 , Z 2 , … , Zn ) \} .$$

Assumption of calculation amount for conspiracy]

In order to establish xi=B^{ai} mod p for each i at the step 2-k-V, the verifiers Vi use a random number bi ε Zq to calculate Bi=g^{b1} mod p and Xi=Ai^{bi} mod p. In other words, it is presumed that each verifier Vi knows the value of the random number bi. This assumption can be formally described as follows.

b-awareness assumption: hereinafter referred to as BAA]

At steps 2-1-V, 2-2-V, . . . and 2-n-V, relative to an arbitrary verifier Vi, there is another verifier Vi′ who outputs not only the cryptograms Bi and Xi, but also outputs the value of the random number bi.

Configuration of simulator]

When the simulator S is constructed as follows, the zero knowledge property can be achieved under the BAA. The simulator S employs the verifiers (V1′, V2′, . . . and Vn′) as sub-routines, and can thus employ the individual random numbers bi.

Algorithm of simulator]

Input: public key v, system parameters p, q and g Output:

$${VIEW}_{n} = \{ ( p , q , g , v ) , ( A 1 , A 2 , … , An ) , ( B 1 , B 2 , … , Bn ) , ( X 1 , X2 , … , Xn ) , ( C 1 , C2 , … , Cn ) , ( Y 1 , Y 2 , … , Yn ) , ( Z 1 , Z 2 , … , Zn ) \}$$

Step 1: For all “i”s (1≦i≦n), random numbers Yi ε Zq and Zi ε Zq are generated, and Ai=V^{Yi}g^{Zi} is calculated.

At this time, the simulation information produced by the simulator S is

VIEWₒ=[(p, q, g, v), (A1, A2, . . . , An)].

Step 2-1-P: The simulator S executes all the verifiers Vi (Vi′) who belong to the group G1. That is, VIEWₒ is input for each verifier Vi′, and (Bi, Xi, bi) are calculated. At this time, Bi=g^{b1} mod p is established. Step 2-1-V: Ci that satisfies Yi=Ci^{b1} mod p is calculated. At this time, the simulation information produced by the simulator S is

VIEW₁=VIEWₒ∪{(Bi, Xi, Ci, Yi, Zi)|Vi εG1}.

Then, steps 2-k-P and 2-k-V are repeated for 2≦k≦n.

Step 2-k-P: The simulator S executes all the verifiers Vi (Vi′) who belong to the group Gk. That is, VIEWₖ₋₁ is input to each verifier Vi′, and (Bi, Xi, bi) are calculated. At this time, Bi=g^{bi} mod p. Step 2-k-V: Ci that satisfies Yi=Ci^{bi} mod p is calculated. At this time, the information simulated by the simulator S is VIEWₖ=VIEWₖ₋₁ ∪ | {(Bi, Xi, Ci, Yi, Zi) | Vi ε Gₖ}.

The communication contents VIEWₙ, which are finally to be simulated, match the probability distribution of the actual communication contents between the prover P and the verifiers V1, V2, . . . and Vn. Therefore, the zero knowledge property is achieved.

Advantages of the Invention]

As is described above, according to the present invention, the secret key of a prover computer is not compromised by the information exchanged by the prover computer and a verifier computer, and user authentication is ensured. Especially when on an asynchronous network, such as the Internet, a prover computer receives data required for authentication as well as verification from multiple verifiers, the zero knowledge property is acquired. Thus, user authentication is ensured without the secret key of a prover computer being compromised on any kind of network.

The present invention can be realized in hardware, software, or a combination of hardware and software. The present invention can be realized in a centralized fashion in one computer system, or in a distributed fashion where different elements are spread across several interconnected computer systems. Any kind of computer system—or other apparatus adapted for carrying out the methods described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after conversion to another language, code or notation and/or reproduction in a different material form.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that other modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

1. A user authentication method, whereby a one-way function F, which should satisfy v=F(g, −s), is determined by employing an integer g that is defined in advance for a relation between a public key v and a secret key s of a prover computer, and whereby a relation is verified between said prover computer and each of multiple verifier computers, comprising the steps of:
said prover computer generating a random number a, obtaining a cryptogram A=the function F(g, a), and transmitting said cryptogram A to said verifier computers;
said verifier computers generating a random number b, obtaining a cryptogram B=the function F(g, b) and a cryptogram X=the function F(A, b), and transmitting said cryptograms B and X to said prover computer;
said prover computer determining whether a relation of said cryptogram X=the function F(B, a) has been established and generating a random number c when said relation has been established, obtaining a cryptogram C=the function F(g, c) and a cryptogram Y=the function F(B, c), or a cryptogram C=the function F(A, c), a cryptogram Y=the function F(X, c) and a cryptogram Z=a function H(a, Y, s), and transmitting said cryptograms C and Y or said cryptograms C, Y and Z to said verifier computers; and
said verifier computers, when said cryptogram Y=the function F(C, b) and said cryptogram A=a function J(v, Y, g, Z) are established, determining that said relation between said prover computer and said verifier computer is correct.

2. The user authentication method according to claim 1, wherein said public key v is obtained by employing prime numbers p and q that satisfy (q|p - 1), and by defining an element of the order q as said integer g.

3. The user authentication method according to claim 1, wherein, by using said public key v and said secret key s, said function F acquires a relation v=F(g, −s)=g^{-s} mod p.

4. The user authentication method according to claim 1, wherein, when a relation X=B^{a} mod p is established, said prover computer generates said random number c.

5. The user authentication method according to claim 1, wherein said function H has a relation H(a, Y, s)=a+Ys mod q.

6. The user authentication method according to claim 1, wherein said function J has a relation J(v, Y, g, Z)=v^{Y}g^{z} mod p.

7. A storage medium on which a user authentication program, which is to be read by a prover computer, is stored whereby a one-way function F, which should satisfy v=F(g, −s), is determined by employing an integer g, which is defined in advance for the relation between a public key v and a secret key s of said prover computer, and whereby a relation is verified between said prover computer and each of multiple verifier computers, said user authentication program permitting said prover computer to perform:
a process for generating a random number a and for obtaining a cryptogram A=the function F(g, a), and for transmitting said cryptogram A to said verifier computers;
a process for receiving cryptograms B and X from said verifier computer, and for employing said cryptograms to determine whether a relation a cryptogram X=the function F (B, a) has been established;
a process for generating a random number c when said relation has been established; and
a process for obtaining a cryptogram C=the function F(g, c) and a cryptogram Y=the function F(B, c), or a cryptogram C=the function F(A, c), a cryptogram Y=the function F(X, c) and a cryptogram Z=the function H(a, Y, s); and
a process for transmitting said cryptograms C and Y, or C, Y and Z, to said verifier computers.

8. A storage medium on which a user authentication program, which is to be read by a prover computer, is stored whereby a one-way function F, which should satisfy v=F(g, −s), is determined by employing an integer g, which is defined in advance for the relation between a public key v and a secret key s of said prover computer, and whereby a relation is verified between said prover computer and each of multiple verifier computers, said user authentication program permitting said verifier computers to perform:
a process for receiving a cryptogram A from said prover computer and for generating a random number b;
a process for obtaining a cryptogram B=the function F(g, b) and a cryptogram X=the function F(A, b), using said random number b and said cryptogram that is received, and for transmitting said cryptograms B and X to said prover computer;
a process for receiving, from said prover computer, a cryptogram C=the function F(g, c) and a cryptogram Y=the function F(B, c), or a cryptogram C=the function F(A, c), a cryptogram Y=the function F(X, c) and a cryptogram Z=the function H(a, Y, s); and
a process, based on said cryptograms C and Y or C, Y and Z that are received, for verifying a relation between said verifier computer and said prover computer when two relations of said cryptogram Y=the function F(C, b) and said cryptogram A=the function J(v, Y, g, Z) are established at the same time.

9. A user authentication apparatus for a prover computer, wherein a one-way function F, which should satisfy v=F(g, −s), is determined by employing an integer g, which is defined in advance, for a relation between a public key v and a secret key s of said prover computer, and wherein a relation is verified between said prover computer and each of multiple verifier computers, said user authentication apparatus comprising:
transmission means, for generating a random number a and obtaining a cryptogram A=the function F(g, a), and for transmitting said obtained cryptogram A to said verifier computers;
reception means, for receiving cryptograms B and X from said verifier computers;
verification means, for employing said cryptograms B and X to determine whether a relation of said cryptogram X=the function F(B, a) has been established;
cryptogram computation means, for generating a random number c when it has been ascertained that said relation has been established, and for obtaining a cryptogram C=the function F(g, c) and a cryptogram Y=the function F(B, c), or a cryptogram C=the function F(A, c), a cryptogram Y=the function F(X, c) and a cryptogram Z=the function H(a, Y, s); and
cryptogram transmission means, for transmitting said cryptograms C and Y or C, Y and Z to said verifier computers.

10. A user authentication apparatus for a prover computer wherein a one-way function F, which should satisfy v=F(g, −s), is determined by employing an integer g, which is defined in advance, for the relation between a public key v and a secret key s of a prover computer, and wherein a relation is verified between said prover computer and each of multiple verifier computers, said user authentication apparatus comprising:
reception means, for receiving a cryptogram A from said prover computer;
transmission means, for generating a random number b, and for employing said random number b and said cryptogram A that is received to obtain a cryptogram B=the function F(g, b) and a cryptogram X=the function F(A, b), and for transmitting said cryptograms B and X to said prover computer;
cryptogram reception means, for receiving from said prover computer a cryptogram C=the function F(g, c) and a cryptogram Y=the function F(B, c) or a cryptogram C=the function F(A, c), a cryptogram Y=the function F(X, c), and a cryptogram Z=the function H(a, Y, s); and
verification means, for performing a procedure, based on said cryptograms C, Y and Z that are received, for verifying a relation between said verifier computers and said prover computer when two relations of said cryptogram Y=the function F(C, b) and said cryptogram A=the function J(v, Y, g, Z) are established at the same time.

11. A user authentication system comprising:
the user authentication apparatus for said prover computer according to claim 9; and
a plurality of user authentication apparatuses for said verifier computers according to claim 10.

12. A user authentication system, wherein a one-way function F, which should satisfy v=F(g, −s), is determined by employing an integer g, which is defined in advance, for the relation between a public key v and a secret key s of a prover computer, and wherein a relation is verified between said prover computer and each of multiple verifier computers, comprising:
transmission means, for said prover computer, for generating a random number a and obtaining a cryptogram A=the function F(g, a), and for transmitting said obtained cryptogram A to said verifier computers;
reception means for said verifier computers, for receiving said cryptogram A from said prover computer;
transmission means for said verifier computers, for generating a random number b with which said cryptogram A is employed to obtain a cryptogram B=the function F(g, b) and a cryptogram X=the function F(A, b), and for transmitting said cryptograms B and X to said prover computer;
reception means for said prover computer, for receiving said cryptograms B and X from said verifier computers;
verification means for said prover computer, for employing said cryptograms B and X to determine whether a relation of said cryptogram X=the function F(B, a) has been established;
cryptogram computation means for said prover computer, for generating a random number c when it is ascertained that said relation has been established, and for obtaining said cryptogram C=the function F(g, c) and said cryptogram Y=the function F(B, c), or said cryptogram C=the function F(A, c) and said cryptogram Y=the function F(X, c), and a cryptogram Z=the function H(a, Y, s); and
cryptogram transmission means for said prover computer, for transmitting said cryptograms C, Y and Z to said verifier computers;
cryptogram reception means, for said verifier computers, for receiving said cryptograms C, Y and Z from said prover computer; and
verification means for said verifier computers, for employing said cryptograms C, Y and Z that are received to verify a relation between said verifier computers and said prover computer when two relations of said cryptogram Y=the function F(C, b) and said cryptogram A=the function J(v, Y, g, Z) are established at the same time.

13. A computer program product comprising a computer usable medium having computer readable program code means embodied therein for causing user authentication, the computer readable program code means in said computer program product comprising computer readable program code means for causing a computer to effect the apparatus of claim 9.

14. A computer program product comprising a computer usable medium having computer readable program code means embodied therein for causing user authentication, the computer readable program code means in said computer program product comprising computer readable program code means for causing a computer to effect the apparatus of claim 10.

15. A computer program product comprising a computer usable medium having computer readable program code means embodied therein for causing user authentication, the computer readable program code means in said computer program product comprising computer readable program code means for causing a computer to effect the system of claim 11.

16. A computer program product comprising a computer usable medium having computer readable program code means embodied therein for causing user authentication, the computer readable program code means in said computer program product comprising computer readable program code means for causing a computer to effect the system of claim 12.

17. An article of manufacture comprising a computer usable medium having computer readable program code means embodied therein for implementing a user authentication method, the computer readable program code means in said article of manufacture comprising computer readable program code means for causing a computer to effect the steps of claim 1.
